(19) United States
(12) Patent Application Publication
(10) Pub. No.: US 2006/0063692 A1
(43) Pub. Date: Mar. 23, 2006

(54) Gun cleaning system, method, and compositions therefor

(75) Inventor: James A. Forst, Holmen, WI (US)

Correspondence Address: VIDAS, ARRETT & STEINKRAUS, P.A., 6109 BLUE CIRCLE DRIVE, SUITE 2000, MINNETONKA, MN, 55343-9185, US

(73) Assignee: Alliant Techsystems Inc, Edina, MN (US)

(21) Appl. No.: 10/969,194

(22) Filed: Sep. 17, 2004

(51) Int. Cl. C11D 17/08; C11D 3/37

(52) U.S. Cl. 510/421; 510/505; 510/499

(57) ABSTRACT

A substantially odorless system for cleaning a firearm, the system including a substantially odorless cleaning composition and a neutralizer. The system may optionally include a substantially odorless lubricant.

### BACKGROUND OF THE INVENTION

The present invention relates to a system for cleaning sporting equipment such as firearms and to methods and compositions used for the same.

The barrel of a firearm, whether a handgun, rifle, or shotgun, must be kept as clean as possible to ensure safe firing of the device and to facilitate accuracy of the round as it travels through the barrel to be discharged. The explosion of the charge to propel the round deposits residue on the interior of the barrel, proximate the trigger, breech, and ejection port assembly which, if permitted to remain, can deteriorate and impair the ability of the firearm to function safely and accurately.

A variety of gun barrel cleaning compositions are known in the art. One common problem associated with most cleaners, however, is that they have a strong and distinctive odor or aroma.

Most fish and game are very sensitive to foreign odors which can have a negative impact on game hunting. A variety of methods have been developed to overcome the problems of odors including the use of lures, attractants and other masking compounds including those which have a pine scent, cedar oils, skunk, fox and deer urine which are typically applied in the vicinity of a gun or bow hunter to mask human odor from game animals. Examples of some of these methods can be found in U.S. Pat. Nos. 2,874,048; 3,666,669; 3,822,211 and 3,421,899.

Thus, hunters typically have no other alternative than to use an odiferous cleaner to keep their weapon clean, and then to employ a separate and distinct masking scent to counteract the tell-tale aroma produced by the cleaner. For a variety of reasons, it is typically undesirable to employ such scents on the surface of a gun.

There remains a need in the art for improved systems, methods and compositions for cleaning equipment employed in game hunting.

### SUMMARY OF THE INVENTION

The present invention relates to a substantially odorless cleaning system for firearms or other sporting equipment for which it is desirable that the cleaning system not leave residual odors which can be detected by game.

Each component of the cleaning system may be available separately, or components may be available together in a kit form. A kit according to the present invention may include at least one cleaning composition and at least one neutralizer. In one embodiment, the neutralizer is pre-applied or impregnated in a patch.

The cleaning composition may be applied to the neutralizing patch and the patch inserted in the firearm barrel with a rod, or the cleaning composition may be applied to a brush and the brush inserted in the firearm barrel. The kit may correspondingly include at least one cleaning implement such as a brush and/or a rod.

The kit may also include dry patches for use in between cleaning and lubricating.

The cleaning kit may further include a substantially odorless lubricant and a second neutralizer. The second neutralizer may also be pre-applied to or impregnated in a cloth. In one embodiment, both the lubricant and the neutralizer are pre-applied to or impregnated in the same cloth. Thus, lubricating and neutralizing may be done in one step. Of course, lubricating and neutralizing may be done as separate steps as well, but one step is desirable for convenience to a firearm user, for example.

In one embodiment, lubricant and neutralizer are both applied to a cloth which is typically a flannel.

In one embodiment, the cloth comprises a blend of silicone, polyalphaolefin oil and neutralizer.

The kit may further include a lubricating oil for use on the firearm mechanisms. The lubricating oil may also be provided in a container. The lubricating oil provided in a container may be the same as or different than the lubricant(s) provided on the cloth.

The present invention also relates to a substantially odor-free method of cleaning and/or lubricating the barrel of a firearm, the method including the steps of providing a cleaning implement compatible with the barrel, providing a substantially odorless cleaning composition, inserting the cleaning implement and cleaning composition simultaneously in the barrel, moving the cleaning implement in a back and forth motion in the gun barrel and providing at least one first neutralizer suitable for neutralizing residual odors from the cleaning composition and inserting the at least one first neutralizer in the barrel.

The cleaning and neutralizing step may be accomplished as a single step by applying the cleaning composition to a patch having neutralizer pre-applied thereto or impregnated in, and then inserting the patch with the use of an appropriate implement such as a rod, into the barrel of the gun.

For some firearms, it is possible to use a single pass with a patch which is pushed all the way through the barrel. Some sportsmen prefer to employ this method and repeat the steps with a new patch until no soiling is visible on the patch. Some firearms, however, are constructed such that this method is not applicable. Thus, some firearms requiring that the patch is pushed back and forth in the barrel.

The method may further include the steps of providing a substantially odorless gun lubricant to wipe down the outer surface of the firearm. A second neutralizer may be employed for neutralizing any residual odors from the lubricant and/or human odors. The second neutralizer may the same as or different than the first, and may be applied simultaneously with the lubricant or after the lubricating step.

Thus, both lubricant and neutralizer may be applied to or impregnated in the same cloth and lubricating and neutralizing accomplished in one step.

The present invention helps prevent the detection of the cleaners and lubricants employed in cleaning of sporting equipment, such as firearms, by game.

Other aspects of the invention are described in the Detailed Description and in the claims below.

### DETAILED DESCRIPTIONS OF THE PREFERRED EMBODIMENTS

While this invention may be embodied in many different forms, there are described in detail herein specific embodiments of the invention. This description is an exemplification of the principles of the invention and is not intended to limit the invention to the particular embodiments illustrated.

All published documents, including all U.S. patent documents, mentioned anywhere in this application are hereby expressly incorporated herein by reference in their entirety. Any copending patent applications, mentioned anywhere in this application are also hereby expressly incorporated herein by reference in their entirety.

In a broad sense, the present invention relates to a method of cleaning the barrel of a firearm whether it be a shotgun, rifle or handgun, with a substantially odorless cleaning composition and neutralizing any residual odors from the cleaning composition with a suitable neutralizing composition. The firearm is then typically lubricated and a neutralizer applied to neutralize any residual odors from the lubricant as well as human odors.

Cleaning and neutralizing may be accomplished in a single step, or cleaning may be accomplished prior to neutralizing.

For cleaning, any suitable cleaning implement may be employed in the present invention. Typically, gun bores or barrels are cleaned with a cleaning brush, rod, or patch, or by a cable that pulls a bristled swab through the bore. Such implements are known in the art. Examples are described in U.S. Pat. No. 6,088,866 and U.S. Pat. No. 5,588,242, each of which is incorporated by reference herein in its entirety. Methods of cleaning gun barrels are described in U.S. Pat. No. 6,088,866.

In one embodiment, the cleaning composition is applied to a patch having neutralizer pre-applied thereto or impregnated therein. A rod is employed to push the patch either through the barrel of the firearm, or back and forth in the firearm.

Some sportsmen prefer to use a single pass in which a patch having cleaner applied thereto is pushed through the barrel of the firearm one time. This process can then be followed with another patch having cleaner applied thereto until no soiling appears on the patch. However, this process is not applicable for all firearms as some have components which would not allow a single pass all the way through the barrel.

In another embodiment, the cleaning composition is applied to a cleaning brush and the brush inserted into the bore and used in a back and forth motion inside the bore. A scent eliminating patch may then be run back and forth inside the bore using the rod.

Thus, cleaning and neutralizing may be accomplished in the same step, or cleaning may be followed by neutralizing.

The neutralizer is employed to neutralize any residual odors left as a result of the cleaning process.

A dry patch may be employed after cleaning.

After cleaning of the firearm, the firearm may be lubricated with a substantially odor-less lubricant. Lubrication typically involves wiping down the outer surface of the firearm with a cloth lightly oiled with the lubricant(s), and lubricant is also typically applied to the mechanisms of the firearm. A neutralizer may also be applied to help eliminate any remaining residual odors from the lubricant and/or human odors.

The lubricant(s) and a neutralizer may be pre-applied to or impregnated in the same cloth, or the sportsman may apply lubricant to a cloth having pre-applied neutralizer, or both.

In one embodiment, a lubricant such as a silicone and neutralizer are pre-applied to a cloth. The sportsman may further apply a lubricant such as polyalphaolefin oil to the cloth prior to lubrication of the firearm.

The neutralizer may also be incorporated in a separate cloth, but desirably, both the lubricant and the neutralizer are incorporated in the same cloth.

Thus, in one embodiment of the present invention, the method involves the primary steps of (1) cleaning/neutralizing and (2) lubricating/neutralizing. Optionally, dry patches may be employed in between the two steps.

An alternative method may include a three-step process including the steps of (1) cleaning, (2) neutralizing and (3) lubricating/neutralizing, or it may be a four-step process including the steps of (1) cleaning, (2) neutralizing, (3) lubricating and (4) neutralizing.

Each of the above embodiments may include the optional steps of employing a dry patch after the cleaning step, and lubricating the firearm mechanisms.

In another aspect, the present invention relates to a kit in which the cleaning composition and neutralizer are available to a consumer in one package.

The kit may also include a lubricant and a neutralizer for neutralizing residual odors left from the lubricant, or human odors. The second neutralizer may be the same as or different than the first.

The kit may also include implements necessary for cleaning such as a brush, rod, dry patches, dry cloth, and so forth or combinations thereof as required.

In one embodiment, the kit may include a rod which is adaptable for a variety of interchangeable tips including both brushes, and tips for insertion of the patch into the barrel of the firearm. The kit may also incorporate tips of different sizes such that it can be used for different firearms.

The patches or cloth may be formed from cotton cloth such as cotton flannel, for example. The terms patch and cloth are terms of art. Patches and cloths may be of the same material, and the difference may be as little as the size of each. A patch is typically smaller, and is sized such as to fit into the barrel of a firearm, while a cloth, used on the outside of the firearm, is larger in size. Such terms are known to those of ordinary skill in the art.

As noted above, a patch to which the cleaning composition is employed may have neutralizer pre-applied thereto or impregnated therein, and a cloth for application of the lubricant may also have neutralizer pre-applied thereto or impregnated therein. Thus, cleaning/neutralizing may be accomplished in one step and lubricating/neutralizing may be accomplished in a single step.

As noted above, some sportsman prefer to use a single pass cleaning system in which one patch is run through the gun barrel, followed by a second patch, and so forth, until no further soiling is seen.

In one embodiment of a kit, a container of odorless cleaning solvent, bore cleaning brushes and tips, a rod, scent eliminating patches, a scentless oil, and an odor neutralizing cloth are included in the kit. The scent eliminating patch comprises a neutralizing composition effective to neutralize residual odors as a result of the cleaning solvent and/or firing residues and the neutralizing cloth comprises a neutralizing composition effective to neutralize any residual odors which may be left from the lubricant.

The scentless oil may be supplied in a container, or the scentless oil may also be pre-applied to a patch, along with a neutralizer, or any combination thereof. In one embodiment, a cloth includes a blend of oils, as well as the neutralizer, pre-applied thereto, or impregnated therein. This lubricating/neutralizing cloth may be supplied in a moisture barrier such as a resealable bag. In one embodiment, the cloth includes silicone, polyalphaolefin oil and neutralizer.

Dry patches may also be included in the kit for use in between the cleaning and lubricating steps.

Thus, a variety of components may be available in each kit.

Of course, it is also possible to have a kit containing only cleaning and neutralizing or lubricating/neutralizing, or any combination thereof, and, each component may be separately available as well. The latter is particularly useful where a kit includes all components, but the supply of one component is exhausted before another, thus requiring refills options.

Furthermore, lubricant may be applied to a cloth which also has neutralizer pre-applied to or impregnated therein, and the cloth used to wipe down the outer surface of the firearm.

The Cleaning Composition

Any suitable cleaning composition may be employed herein. Desirably, the cleaning composition is a substantially odorless cleaning composition. Suitably, the cleaning composition includes at least one carrier solvent. Suitably, the carrier solvent is water. Other components which may be incorporated in the cleaning composition include, but are not limited to, detergents and/or surfactants, rust-inhibitors, cleaning solvents, corrosion inhibitors, biocides, fungicides, and so forth, as well as mixtures thereof.

The cleaning composition includes at least one solvent for improving and intensifying the solvency of the composition. Any suitable solvent may be employed herein. Most suitably, the solvents have relatively low odor when compared with other solvents. Both polar and non-polar solvents as well as combinations thereof may be employed herein and include, but are not limited to, water, n-methyl-2 pyrrolidone, polyalkylene glycols including ethylene and propylene glycols, and so forth.

Preferred solvents include n-methyl-2-pyrrolidone and dialkylene glycols, in particular diethylene glycol.

Mixtures of solvents may also be employed herein.

The solvent or mixture thereof may be employed in amounts of about 1% to about 50% and suitably about 5% to about 30% and most suitably about 10% to about 20% by weight.

It is desirable to incorporate an effective amount of at least one material for copper dissolution. Examples of materials suitable for copper dissolution include, but are not limited to, amines including primary, secondary and tertiary amines, amino alcohols, carboxyl group-bearing nitrogenous compounds including the ethanolamines such as the mono-, di- and triethanolamine, and so forth. These materials also help to stabilize the pH in order to minimize corrosion. Desirably such compounds are basic.

Examples of suitable primary aliphatic amines include, but are not limited to, ammonia, methylamine, ethylamine, n-propylamine, isopropylamine, n-butylamine, iso-butylamine, sec-butylamine, tert-butylamine, pentylamine, tert-amylamine, cyclopentylamine, hexylamine, cyclohexylamine, heptylamine, octylamine, nonylamine, decylamine, dodecylamine, cetylamine, methylenediamine, ethylenediamine, tetraethylenepentamine, and so forth.

Examples of suitable secondary aliphatic amines include, but are not limited to, dimethylamine, diethylamine, di-n-propylamine, di-iso-propylamine, di-n-butylamine, di-iso-butylamine, di-sec-butylamine, dipentylamine, dicyclopentylamine, dihexylamine, dicyclohexylamine, diheptylamine, dioctylamine, dinonylamine, didecylamine, didodecylamine, dicetylamine, N,N-dimethyl-methylenediamine, N,N-dimethylethylenediamine, N,N-dimethyltetraethylenepentamine, and so forth.

Examples of suitable tertiary aliphatic amines include, but are not limited to, trimethylamine, triethylamine, tri-n-propylamine, tri-iso-propylamine, tri-n-butylamine, tri-iso-butylamine, tri-sec-butylamine, tripentylamine, tricyclopentylamlne, trihexylamine, tricyclohexylamine, triheptylamine, trioctylamine, trinonylamine, tridecylamine, tridodecylamine, tricetylamine, N,N,N′,N′-tetramethylmethylenediamine, N,N,N′,N′-tetra-methylethylenediamine, N,N,N′,N′-tetramethyltetraethylenepentamine, and so forth.

Examples of suitable mixed amines include, but are not limited to, dimethylethylamine, methylethylpropylamine, benzylamine, phenethylamine, and benzyldimethylamine.

Examples of suitable aromatic and heterocyclic amines include aniline derivatives (e.g., aniline, N-methylaniline, N-ethylaniline, N-propylaniline, N,N-dimethylaniline, 2-methylaniline, 3-methylaniline, 4-methylaniline, ethylaniline, propylaniline, trimethylaniline, 2-nitroaniline, 3-nitroaniline, 4-nitroaniline, 2,4-dinitroaniline, 2,6-dinitroaniline, 3,5-dinitroaniline, and N,N-dimethyltoluidine), diphenyl(p-tolyl)amine, methyldiphenylamine, triphenylamine, phenylenediamine, naphthylamine, diaminonaphthalene, pyrrole derivatives (e.g., pyrrole, 2H-pyrrole, 1-methylpyrrole, 2,4-dimethylpyrrole, 2,5-dimethylpyrrole, and N-methylpyrrole), oxazole derivatives (e.g., oxazole and isooxazole), thiazole derivatives (e.g., thiazole and isothiazole), imidazole derivatives (e.g., imidazole, 4-methylimidazole, and 4-methyl-2-phenylimidazole), pyrazole derivatives, furazan derivatives, pyrroline derivatives (e.g., pyrroline and 2-methyl-1-pyrroline), pyrrolidine derivatives (e.g., pyrrolidine, N-methylpyrrolidine, pyrrolidinone, and N-methylpyrrolidone), imidazoline derivatives, imidazolidine derivatives, pyridine derivatives (e.g., pyridine, methylpyridine, ethylpyridine, propylpyridine, butylpyridine, 4-(1-butylpentyl)pyridine, dimethylpyridine, trimethylpyridine, triethylpyridine, phenylpyridine, 3-methyl-2-phenylpyridine, 4-tert-butylpyridine, diphenylpyridine, benzylpyrldine, methoxypyridine, butoxypyridine, dimethoxypyridine, 1-methyl-2-pyridine, 4-pyrrolidinopyridine, 1-methyl-4-phenylpyrldine, 2-(1-ethylpropyl)-pyridine, aminopyridine, and dimethylaminopyridine), pyridazine derivatives, pyrimidine derivatives, pyrazine derivatives, pyrazoline derivatives, pyrazolidine derivatives, piperidine derivatives, piperazine derivatives, morpholine derivatives, indole derivatives, isoindole derivatives, 1H-indazole derivatives, indoline derivatives, quinoline derivatives (e.g., quinoline and 3-quinoline-carbonitrile), isoquinoline derivatives, cinnoline derivatives, quinazoline derivatives, quinoxaline derivatives, phthalazine derivatives, purine derivatives, pteridine derivatives, carbazole derivatives, phenanthridine derivatives, acridine derivatives, phenazine derivatives, 1,10-phenanthroline derivatives, adenine derivatives, adenosine derivatives, guanine derivatives, guanosine derivatives, uracil derivatives, uridine derivatives, and so forth.

Other suitable amine compounds include, but are not limited to, include tris{2-(methoxymethoxy)-ethyl)amine, tris(2-(methoxyethoxy)ethylamine, tris[2-((2-methoxyethoxy)methoxy}ethyl]amine, tris(2-(2-methoxyethoxy)-ethyl)amine, tris{2-(1-methoxyethoxy)ethyl)amine, tris{2-(1-ethoxyethoxy)ethyl)amine, tris(2-(1-ethoxypropoxy)-ethyl}amine, tris[2-((2-hydroxyethoxy)ethoxy)ethyl]amine, 4,7,13,16,21,24-hexaoxa-1,10-diazabicyclo[8.8.8]hexacosane, 4,7,13,18-tetraoxa-1,10-diazabicyclo[8.5.5]eicosane, 1,4,10,13-tetraoxa-7,16-diazabicyclooctadecane, 1-aza-12-crown-4,1-aza-15-crown-5, 1-aza-18-crown-6, and so forth.

Examples of suitable carboxyl group-bearing nitrogenous compounds include aminobenzoic acid, indolecarboxylic acid, and amino acid derivatives (e.g. nicotinic acid, alanine, alginine, aspartic acid, glutamic acid, glycine, histidine, isoleucine, glycylleucine, leucine, methionine, phenylalanine, threonine, lysine, 3-aminopyrazine-2-carboxylic acid, and methoxyalanine). Examples of suitable sulfonyl group-bearing nitrogenous compounds include 3-pyridinesulfonic acid and pyridinium p-toluenesulfonate. Examples of suitable hydroxyl group-bearing nitrogenous compounds, hydroxyphenyl group-bearing nitrogenous compounds, and alcoholic nitrogenous compounds include 2-hydroxypyridine, aminocresol, 2,4-guinolinediol. 3-indolemethanol hydrate, monoethanolamine, diethanolamine, triethanolamine. N-ethyldiethanolamine. N,N-diethylethanolamine, trilsopropanolamine, 2,2′-iminodiethanol, 2-aminoethanol, 3-amino-1-propanol, 4-amino-1-butanol, 4-(2-hydroxyethyl)morpholine, 2-(2-hydroxyethyl)pyridine, 1-(2-hydroxyethyl)piperazine, 1-[2-(2-hydroxyethoxy)ethyl]-piperazine, piperidine ethanol, 1-(2-hydroxyethyl)-pyrrolidine, 1-(2-hydroxyethyl)-2-pyrrolidinone, 3-piperidino-1,2-propanediol, 3-pyrrolidino-1,2-propanediol, 8-hydroxyjulolidine, 3-quinuclidinol, 3-tropanol, 1-methyl-2-pyrrolidine ethanol, 1-aziridine ethanol, N-(2-hydroxy-ethyl)phthalimide, and N-(2-hydroxyethyl)isonicotinamide. Examples of suitable amide derivatives include formamide, N-methylformamide, N,N-dimethylformamide, acetamide, N-methyl-acetamide, N,N-dimethylacetamide, propionamide, and benzamide. Suitable imide derivatives include phthalimide, succinimide, maleimide, and so forth.

Compounds effective in the removal of copper are discussed, for example, in U.S. Pat. No. 4,666,528, which is incorporated by reference herein in its entirety.

The above lists are intended for illustrative purposes only, and not as a limitation on the scope of the present invention.

The most desirable compounds for dissolution of copper are those which exhibit the least amount of odor while maintaining effective copper dissolution. For example, ammonia exhibits a stronger odor than do some of the other nitrogen-containing compounds.

Mono-, di- and triethanolamine are effective at dissolving copper, and while monoethanolamine may be more effective at dissolving copper, it exhibits a slightly stronger odor than does triethanolamine.

Thus, it is desirable to employ a copper-dissolving compound which has a balance of acceptable copper dissolution and lower odor.

It is also desirable to incorporate a corrosion inhibitor. Examples of corrosion inhibitors are the amine carboxylates. One example of such an amine carboxylate is AQUALOX®232, commercially available from Alox Corporation located in Niagara Falls, N.Y.,

The corrosion inhibitor or combination thereof, may be employed in amounts of about 0.1% to about 20%, and suitably about 0.5% to about 10%.

The cleaner also preferably includes at least one surfactant. Suitable surfactants include ionic surfactants including cationic and anionic surfactants, non-ionic surfactants, and zwitterionic surfactants (often referred to as amphoteric because they often contain a base coupled to an acid) or a combination thereof. The surfactant assists in emulsifying dirt, grease, oil, gun powder, rust, corrosion and/or grime. The surfactant also assists in wetting the surface of the firearm by lowering the surface tension of the fluid to allow the other components of the cleaner to perform their functions. Any suitable surfactant known for such purposes may be employed herein.

Examples of suitable nonionic surfactants include, but are not limited to, polyethylene, polypropylene, and polybutylene oxide condensates of alkyl phenols (alkoxylated alkyl phenols) such as ethoxylated nonyl phenol available from Akzo Nobel under the tradename of WITCONOL® such as NP-90 and those available from Huntsman under the tradename of SURFONIC® N and ethoxylated octyl phenol available from Dow under the tradename of TRITON® such as X-45 and X-102 and those available from Huntsman under the tradename of SURFONIC® OP; ethylene oxide/propylene oxide block copolymers such as those available under the tradename of PLURONIC® from BASF in Mount Olive, N.J.; alkoxylated alcohols; alkylpolyglycosides; glycol esters; fatty acid amides; alkanolamines; alkanolamides; POE(20) sorbitan monooleate; polyethylene glycol cocoate; and so forth.

A preferred non-ionic surfactant is ethoxylated nonyl phenol.

Examples of suitable cationic surfactants include, but are not limited to, quaternary ammonium compounds in which one of the alkyl groups is a long chain

Examples of suitable anionic surfactants include, but are not limited to, soaps, sulfates, sulfonates and carboxylates such as alkyl carboxylate salts, and so forth. More specifically, useful anionic surfactants include alkyl sulfates and sulfonates, alkyl ether sulfates and sulfonates, alkyl aryl sulfates and sulfonates such as alkyl benzene sulfonate, aryl sulfates and sulfonates, sulfated fatty acid esters, sulfonated fatty acids, sulfated monoglycerides, sulfonated olefins, primary or secondary alkane sulfonates, alkyl sulfosuccinates, acyl taurates, methyl acyl taurates, acyl isethionates, alkyl glyceryl ether sulfonate, sulfonated methyl esters, alkyl phosphates, acyl glutamates, acyl sarcosinates, alkyl sulfoacetates, acylated peptides, alkyl ether carboxylates, acyl lactylates, anionic fluorosurfactants, ethoxylated alkyl sulfates, alkyl glyceryl ether sulfonates, fatty acyl glycinates, alpha-sulfonated fatty acids, their salts and/or their esters, alkyl ethoxy carboxylates, and so on and so forth, and mixtures thereof.

Any suitable counter cation, M, can be used on the anionic surfactant. Examples of counter cations include, but are not limited to, sodium, potassium, calcium, magnesium, ammonium, amines, monoethanolamine, diethanolamine, triethanolamine and so forth. Some counter cations may be more suitable than others depending on the anion with which they are paired.

Examples of suitable zwitterionic or amphoteric surfactants include, but are not limited to, betaines such as alkyl betaines, alkyl amidobetaines, sulfobetaines, imidazolinium betaines, aminopropionates, aminoglycinates, amine oxides, sultaines, quaternary ammonium compounds including the carboxylates, sulfates and sulfonates, and so forth. Zwitterionic surfactants are discussed in U.S. Pat. Nos. 4,898,690 and 6,300,508, both of which are incorporated by reference herein in its entirety.

Surfactants are known in the art and are discussed in detail in McCutcheon's Detergents and Emulsifiers, 1999, North American Edition, MC Publishing Co. Surfactants are also discussed in U.S. Pat. Nos. 3,929,678, 6,680,286 and 6,699,828, each of which is incorporated by reference herein in its entirety.

The surfactant may be employed in amounts of about 0.01% to about 20%, suitably about 0.05% to about 10% and most suitably about 0.1% to about 5%.

Biocides may be optionally employed in the cleaning composition. Suitable biocides include those available under the tradename of DOWICIL® from Dow Chemical Co. in Midland, Mich., and methylchloroisothiazolinone and methylisothiazolinone which are both from Rohm and Haas Co.

The above lists are intended for illustrative purposes only, and are not intended to limit the scope of the present invention.

The concentrations of each ingredient are intended for illustrative purposes only, and not intended to limit the scope of the present invention.

The compositions are suitably aqueous based, the remainder being water. Water is typically employed in amounts of about 50% to about 90%.

Odor Neutralizer for Cleaning Composition

A neutralizer may be employed to counteract any trace odors which may be left as a result of using the cleaning composition such as those odors left by cleaning solvents, and any odors from fouling in the gun barrel. The neutralizer may also neutralize human odors which are left on the firearm.

One example of a suitable neutralizer is cylcodextrin. Such a neutralizer is available under the tradename of CAVASOL® W7 HP available from Wacker Biochem Corp. in Adrian, Mich.

Such neutralizers may be incorporated into a patch by application of or impregnation of the patch with the neutralizing composition.

Suitable coverage rates are between about 0.1 g neutralizer/1 square yard of cloth to about 1 g neutralizer/1 square yard of cloth. More suitably about 0.25 g neutralizer/1 square yard of cloth to about 0.5 g neutralizer/1 square yard of cloth.

The Lubricant

Any suitable substantially scent-free oil or lubricant may be employed herein. Examples of suitable lubricants include, but are not limited to, odorless mineral oils, polyalpholefin oils (PAOs) and so forth. One suitable example is PAO-6 available from Lube-Tech in Golden Valley, Minn.

The lubricant may be applied to a cloth. In one embodiment, lubricant is applied to a silicone cloth which is typically a flannel cloth with silicone already impregnated in the cloth. Alternatively, a blend of silicone and the scent-free oil may be applied to or impregnated in the same cloth at one time.

One example of a silicone is that available from General Electric and identified as SF96-100.

The silicone/oil blend may be applied to the cloth at a rate of about 0.01 to about 1 gallon silicone/oil blend per square yard of cloth.

Odor Neutralizer

The lubricant may be followed by another neutralizing step which may employ the same neutralizer used after the cleaning composition, or which may be different than a first neutralizer employed.

The odor neutralizer may also be applied to or impregnated in, the lubricant-containing cloth described above. It has been found that the lubricant and odor neutralizer do not negatively impact one another if applied to the same cloth.

Thus, the cloth described above may have silicone, oil and neutralizer all applied to or impregnated in the same cloth.

A suitable neutralizer is cyclodextrin as described above.

Suitable coverage rates are between about 0.1 g neutralizer/1 square yard of cloth to about 1 g neutralizer/1 square yard of cloth. More suitably about 0.25 g neutralizer/1 square yard of cloth to about 0.5 g neutralizer/1 square yard of cloth.

In one embodiment, a cloth is impregnated with silicone, a scent-free oil such as polyalphaolefin oil, and cyclodextrin.

### EXAMPLES

### Example 1

A cleaning composition was prepared according to the following formula:

Cleaning Composition

6.0% n-methyl pyrrolidone (solvent( )
10.0% diethylene glycol (solvent)
6.0% triethanolamine (copper dissolution)
0.10% ethoxylated nonyl phenol surfactant
0.50% AQUALOX® 232 (corrosion inhibitor/surfactant)
   Odor Neutralizer Patch
0.37 grams neutralizer/1 square yard silicone cloth (CAVASOL® W7 HP cyclodextrin)
   Odorless Oil
PAO-6 (polyalphaolefin available from Lube-Tech)
   Odor Neutralizing Silicone Cloth
0.37 grams neutralizer/1 square yard of silicone cloth (SF96-100 silicone available from General Electric)
0.014 gallons silicone/PAO-6 blend per square yard of cloth (12% Silicone Oil (GE SF96-100)/88% Scent Free Oil (PAO-6)

A brush suitable for cleaning a gun bore was saturated with the cleaning composition, and the brush run back and forth inside the gun bore. The neutralizing patch was inserted into the gun barrel using a cleaning rod. A dry patch was inserted into the gun barrel and run back and forth following the cleaning and neutralizing steps.

A cloth, lightly oiled as described above, with the blend of silicone/polyalphaolefin oil and neutralizer was then used to wipe down the outer surface of the firearm.

The above disclosure is intended to be illustrative and not exhaustive. This description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A substantially odorless system for cleaning the barrel of a firearm, the system comprising:
a) a substantially odorless cleaning composition; and
b) a neutralizer;
wherein said neutralizer is applied to said barrel of said firearm for mitigating any residual odors from said substantially odorless cleaning composition.

2. The system of claim 1 further comprising a substantially scentless lubricant.

3. The system of claim 2 wherein said scentless lubricant is selected from the group consisting of polyalphaolefin, substantially odor-free mineral oil, or mixtures thereof.

4. The system of claim 1 wherein said cleaning composition comprises at least one amine, amino alcohol, carboxyl group-bearing nitrogenous compound or mixture thereof.

5. The system of claim 1 wherein said cleaning composition comprises at least one member selected from the group consisting of monoethanolamine, diethanolamine, triethanolamine.

6. The system of claim 1 wherein said cleaning composition comprises at least one corrosion inhibitor.

7. The system of claim 6 wherein said corrosion inhibitor is an amine carboxylate.

8. The system of claim 1 wherein said cleaning composition comprises at least one surfactant.

9. The system of claim 8 wherein said at least one surfactant is nonionic.

10. The system of claim 9 wherein at least one surfactant is a nonyl phenol alkoxylate, an octyl phenol alkoxylate, an ethylene oxide/propylene oxide block copolymer, or mixture thereof.

11. The system of claim 10 wherein said at least one surfactant is nonyl phenol ethoxylate.

12. The system of claim 1 wherein said cleaning composition comprises at least one solvent which is n-methyl-2 pyrrolidone, a dialkylene glycol or mixture thereof.

13. The system of claim 1 wherein said neutralizer comprises cyclodextrin.

14. The system of claim 1 wherein said cleaning composition comprises water.

15. A kit for cleaning the barrel of a firearm, the kit comprising:
a) at least one substantially odorless cleaning composition; and
b) at least one neutralizer.

16. The kit of claim 15 wherein said substantially odorless cleaning composition is in a container.

17. The kit of claim 15 further comprising a substantially scentless lubricant.

18. The kit of claim 17 wherein said substantially scentless lubricant is in a container, pre-applied to a cloth or both.

19. The kit of claim 15 wherein said at least one neutralizer is pre-applied to at least one patch.

20. The kit of claim 15 further comprising a second neutralizer which is the same as or different than said first neutralizer.

21. The kit of claim 20 wherein said second neutralizer is pre-applied to at least one cloth.

22. The kit of claim 21 wherein said cloth comprises at least one lubricant.

23. The kit of claim 22 wherein said at least one lubricant is selected from the group consisting of silicone, polyalphaolefin oil, substantially odorless mineral oil, or mixtures thereof.

24. The kit of claim 15 further comprising a cleaning brush, a cleaning rod or combination thereof.

25. The kit of claim 15 further comprising dry patches.

26. The kit of claim 15, said substantially odorless cleaning composition comprises:
a) water;
b) at least one surfactant;
c) at least one solvent selected from the group consisting of n-methyl-2-pyrrolidone, dialkylene glycols and mixtures thereof; and
d) at least one member selected from the group consisting of amines, amino alcohols, carboxyl group-bearing nitrogenous compounds or mixtures thereof; and
e) at least one corrosion inhibitor.

27. The kit of claim 26 wherein said carboxyl group-bearing nitrogenous compound is mono-, di- or triethanolamine.

28. The kit of claim 26 wherein said corrosion inhibitor is an amine carboxylate.

29. A substantially odorless method of cleaning a barrel of a firearm, the method comprising the steps of:
a) providing a cleaning implement compatible with said barrel;
b) providing a substantially odorless cleaning composition;
c) inserting said cleaning implement and cleaning composition simultaneously in said barrel;
d) pushing said cleaning implement in said gun barrel;
e) providing at least one first neutralizer suitable for said cleaning composition; and
f) inserting said at least one first neutralizer in said barrel.

30. The method of claim 29, the firearm having an outer surface, the method further comprising the steps of providing a substantially odorless gun lubricant, providing a second neutralizer the same as or different than said first neutralizer, and applying said lubricant and said neutralizer to said outer surface of said firearm.

31. The method of claim 30 wherein said neutralizer and said lubricant are applied to said outer surface of said firearm simultaneously.

32. The method of claim 30 wherein said neutralizer and said lubricant are applied to a cloth.

33. The method of claim 29 wherein said cleaning composition and said at least one first neutralizer are inserted into said barrel of said firearm simultaneously.

34. The method of claim 33 wherein said method comprising the step of applying said cleaning composition to a patch having neutralizer pre-applied thereto.

35. The method of claim 29 wherein said cleaning composition is inserted into said barrel of said firearm prior to said neutralizer.
